(19) United States
(12) Patent Application Publication
(10) Pub. No.: US 2020/0324694 A1
(43) Pub. Date: Oct. 15, 2020

(54) EDGE-LIT READING LAMP INCLUDING AN ANTI-GLARE PLATE AND A DIFFUSER PLATE FOR REDUCING VISIBLE BLUE LIGHT

(71) Applicant: GM Global Technology Operations LLC, Detroit, MI (US)

(72) Inventors: Houli Chen, Shanghai (CN); Xue Tian, Shanghai (CN); Li Shen, Shanghai (CN)

(21) Appl. No.: 16/381,817

(22) Filed: Apr. 11, 2019

(51) Int. Cl. B60Q 3/64; B60Q 3/76; F21V 8/00

(52) U.S. Cl. CPC B60Q 3/64; B60Q 3/76; G02B 6/0091; G02B 6/0068; G02B 6/0055; G02B 6/0051

(57) ABSTRACT

An edge-lit reading lamp for an automobile is disclosed. The edge-lit reading lamp includes a housing having an open end and one or more sidewalls and a plurality of light emitting diodes (LEDs) disposed along the one or more sidewalls of the housing. The plurality of LEDs are configured to emit visible light, where the visible light includes blue visible light. The edge-lit reading lamp also includes a light guide plate surrounded by the plurality of LEDs and a diffuser plate positioned to receive the visible light emitted by the plurality of LEDs. The edge-lit reading lamp also includes anti-glare plate having an anti-glare plate having a plurality of light scattering microstructures disposed along a surface of the anti-glare plate that are oriented to face away from the visible light generated by the plurality of LEDs.

### INTRODUCTION

The present disclosure relates to edge-lit reading lamps for automobiles. More particularly, the present disclosure relates to an edge-lit reading lamp that includes an anti-glare plate and a diffuser plate for reducing visible blue light.

Reading lamps are used in a variety of locations. For example, an automobile may include interior reading lamps. An interior reading lamp is sometimes referred to as a map light. The map light provides a focused beam of light for illuminating a specific object, such as a map. In contrast, an interior dome light illuminates the entire interior cabin of a vehicle.

There are various factors that contribute to a comfortable reading environment for an individual. For example, excessive blue light may cause digital eye strain. Blue light is the portion of the visible light spectrum with the shortest wavelengths and highest energy. As a result, visible blue light scatters more easily than other visible light. Thus, reading lamps that emit significant amounts of blue light may contribute to digital eye strain. In addition to the issues caused by blue light, reading lamps that provide excessive light or glare may result in eye fatigue. Furthermore, some individuals may also find some reading lights produce low quality light.

Thus, while current reading lamps achieve their intended purpose, there is a need for new and improved reading lamps that provide high quality light.

### SUMMARY

According to several aspects an edge-lit reading lamp for an automobile is disclosed. The edge-lit reading lamp includes a housing having an open end and one or more sidewalls and a plurality of light emitting diodes (LEDs) disposed along the one or more sidewalls of the housing. The plurality of LEDs are configured to emit visible light, where the visible light includes blue visible light. The edge-lit reading lamp also includes a light guide plate surrounded by the plurality of LEDs and a diffuser plate positioned to receive the visible light emitted by the plurality of LEDs. The diffuser plate includes light diffusion particles configured to adsorb at least enough of the visible blue light from the visible light emitted by the plurality of LEDs to result in a visible light spectrum including an amount of the visible blue light that is equal to or less than a remainder of color frequencies in the visible light spectrum. The edge-lit reading lamp also includes an anti-glare plate having a plurality of light scattering microstructures disposed along a surface of the anti-glare plate that are oriented to face away from the visible light generated by the plurality of LEDs.

In one aspect of the disclosure, the anti-glare plate is configured to reduce a unified glare rating (UGR) of the visible light generated by the plurality of LEDs that exits the reading lamp to a satisfactory level.

In another aspect of the disclosure, the satisfactory level is 19.

In yet another aspect of the disclosure, the plurality of light scattering microstructures are nano-sized.

In one aspect of the disclosure, the plurality of light scattering microstructures each include a substantially rounded profile.

In another aspect of the disclosure, the anti-glare plate is positioned within the open end of the housing.

In yet another aspect of the disclosure, the plurality of LEDs are white LEDs.

In one aspect of the disclosure, the edge-lit reading lamp further comprises a light reflective film disposed along an inner bottom surface of the housing.

In another aspect of the disclosure, the light reflective film includes a thickness of about 0.3 millimeters.

In yet another aspect of the disclosure, the light guide plate includes a thickness of about two millimeters.

In one aspect of the disclosure, the diffuser plate adsorbs enough visible blue light to result in the edge-lit reading lamp emitting less of the visible blue light when compared to the remainder of color frequencies in the visible light spectrum.

In another aspect of the disclosure, the diffuser plate includes a thickness of about 0.3 millimeters.

In yet another aspect of the disclosure, the anti-glare plate includes a thickness of about 0.8 millimeters.

In one aspect of the disclosure, the housing includes a height of about four millimeters.

In another aspect of the disclosure, the light diffusion particles are constructed of at least one of the following: titanium dioxide (TiO2), silicon dioxide (SiO2), aluminum oxide (A1203), hollow SiO2, zinc oxide (ZrO2), and cerium oxide (CeO2), and where the light diffusion particles include a particle diameter of ranging from about 5 nanometers to about 200 nanometers.

In one aspect of the disclosure, an edge-lit reading lamp is disclosed. The edge-lit reading lamp includes a housing having an open end and one or more sidewalls, where the housing includes a height of about four millimeters. The edge-lit reading lamp also includes a plurality of white LEDs disposed along the one or more sidewalls of the housing. The plurality of white LEDs are configured to emit visible light, and the visible light includes blue visible light. The edge-lit reading lamp also includes a light guide plate surrounded by the plurality of white LEDs and a diffuser plate positioned to receive the visible light emitted by the plurality of white LEDs. The diffuser plate includes light diffusion particles configured to adsorb at least enough of the visible blue light from the visible light emitted by the plurality of white LEDs to result in a visible light spectrum including an amount of the visible blue light that is equal to or less than a remainder of color frequencies in the visible light spectrum. The edge-lit reading lamp also includes an anti-glare plate having a plurality of light scattering microstructures disposed along a surface of the anti-glare plate that are oriented to face away from the visible light generated by the plurality of LEDs.

In one aspect of the disclosure, the anti-glare plate is configured to reduce a unified glare rating (UGR) of the visible light generated by the plurality of LEDs that exits the reading lamp to a satisfactory level.

In another aspect of the disclosure, the satisfactory level is 19.

In yet another aspect of the disclosure, the plurality of light scattering microstructures are nano-sized.

In still another aspect of the disclosure, the light diffusion particles are constructed of at least one of the following: titanium dioxide (TiO2), silicon dioxide (SiO2), aluminum oxide (Al2O3), hollow SiO2, zinc oxide (ZrO2), and cerium oxide (CeO2), and where the light diffusion particles include a particle diameter of ranging from about 5 nanometers to about 200 nanometers.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-sectioned schematic view of a housing for the disclosed edge-lit reading lamp according to an exemplary embodiment;

FIG. 2 is a top view of the reading lamp including the housing shown in FIG. 1 and a circuit board according to an exemplary embodiment;

FIG. 3A illustrates a visible light spectrum generated by a conventional reading lamp according to an exemplary embodiment;

FIG. 3B illustrates a visible light spectrum generated by the disclosed reading lamp according to an exemplary embodiment;

FIG. 4 is a graph illustrating a tilt-angle simulation for the reading lamp according to an exemplary embodiment;

FIG. 5A is a polar intensity diagram when the reading lamp is tilted about thirty degrees according to the tilt-angle simulation shown in FIG. 4 according to an exemplary embodiment; and

FIG. 5B is a polar intensity diagram when the reading lamp is tilted about forty five degrees according to an exemplary embodiment.

### DETAILED DESCRIPTION

The following description is merely exemplary in nature and is not intended to limit the present disclosure, application, or uses.

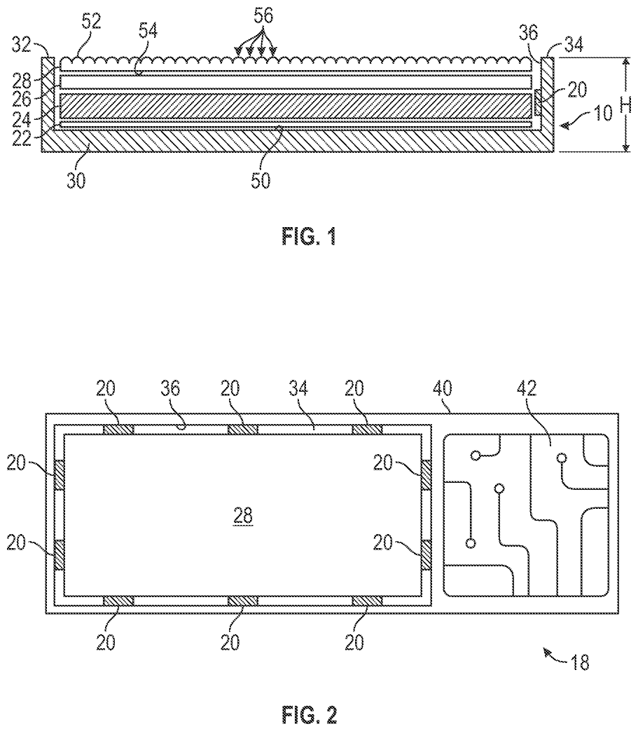

Referring to FIG. 1, a cross-sectioned schematic view of a housing 10 for a reading lamp 18 is illustrated (the reading lamp 18 is shown in FIG. 2). The housing 10 contains a plurality of light emitting diodes (LEDs) 20 (only one LED 20 is visible in FIG. 1), a light reflective film 22, a light guide plate 24, a diffusion plate 26, and an anti-glare plate 28. The housing 10 includes a closed end 30 and an open end 32. A plurality of side walls 34 are connected to the closed end 30 of the housing 10. The LEDs 20 are disposed along an inner surface 36 of the side walls 34 of the housing 10. Therefore, the reading lamp 18 is illuminated based on light sources located along the side walls 34 of the housing 10. Accordingly, the reading lamp 18 is referred to as an edge-lit reading lamp 18.

In one embodiment, the LEDs 20 may be white LEDs. However, it is to be appreciated that the reading lamp 18 is not limited to a specific type of LED, and in an alternative embodiment red, blue, and green (RGB) LEDs may be used instead. White LEDs tend to emit a large amount of visible blue light, which includes a wavelength ranging from about 450 to about 495 nanometers. However, as explained below, the diffusion plate 26 is configured to reduce the amount of visible blue light emitted by the white LEDs 20. Therefore, even if white LEDs are employed, the reading lamp 18 still emits relatively low levels of visible blue light.

FIG. 2 is a top view of the reading lamp 18. The housing 10 is placed within a main housing 40 of the reading lamp 18. FIG. 2 illustrates a plurality of LEDs 20 disposed around the inner surface 36 of the side walls 34 of the housing 10. In the non-limiting embodiment as shown, the plurality of LEDs 20 are positioned about equidistant to one another. The main housing 40 of the reading lamp 18 also includes a circuit board 42 that provides electrical power to the LEDs 20. In one non-limiting embodiment, the circuit board 42 may be a printed circuit board.

The reading lamp 18 provides a focused beam of visible light and may be used in a variety of applications. Some examples of applications include, but are not limited to, automobiles, aircraft, home appliances, and in manufacturing environments. In one specific application, the reading lamp 18 may be a map light for an automobile such as a sport utility vehicle, van, or sedan.

The housing 10 of the reading lamp 18 is relatively compact and requires significantly less packaging space when compared to some other types of conventional reading lamps. Referring to FIG. 1, in one embodiment a height H of the housing 10 may be about four millimeters. However, it is to be appreciated that the housing 10 may include other dimensions for the height H instead.

Continuing to refer to FIG. 1, the light reflective film 22 is disposed along an inner bottom surface 50 of the housing 10. The light reflective film 22 is positioned substantially parallel with respect to the anti-glare plate 28. The reflective film 22 may be a white film configured to reflect incident light generated by the LEDs 20 or, alternatively, a mirror reflective film. A mirror reflective film is created by depositing metal upon a film. In one non-limiting example, the light reflective film includes a thickness of about 0.3 millimeters.

The light guide plate 24 is disposed directly above the light reflective film 22 and is located entirely within the housing 10. The light guide plate 24 is positioned substantially parallel with respect to the diffuser plate 26 and is surrounded by the plurality of LEDs 20. Therefore, the visible light emitted by the LEDs 20 is transmitted to the light guide plate 24. The light guide plate 24 then directs the visible light generated by the LEDs 20 in a direction towards the diffuser plate 26. In one non-limiting embodiment, the light guide plate 24 is constructed of poly(methyl methacrylate) (PMMA) and includes a thickness of about two millimeters.

Referring to FIG. 1, the diffusion plate 26 is located between the light guide plate 24 and the anti-glare plate 28. The diffusion plate 26 is a substantially transparent prismatic lighting plate that may be constructed of materials such as, for example, acrylic and polycarbonate. Specifically, the diffusion plate 26 includes a plurality of light diffusion configured to adsorb at least enough of the visible blue light from the visible light emitted by the plurality of LEDs 20 to result in a visible light spectrum including an amount of the visible blue light that is equal to or less than a remainder of color frequencies in the visible light spectrum. The light diffusion particles are constructed of at least one of the following: titanium dioxide (TiO₂), silicon dioxide (SiO₂), aluminum oxide (Al₂O₃), hollow SiO₂, zinc oxide (ZrO₂), and cerium oxide (CeO₂), where the light diffusion particles may include a particle diameter of ranging from about 5 nanometers to about 200 nanometers. In one non-limiting embodiment, the diffuser plate 26 includes a thickness of about 0.3 millimeters, however, it is to be appreciated that other thicknesses may be used as well.

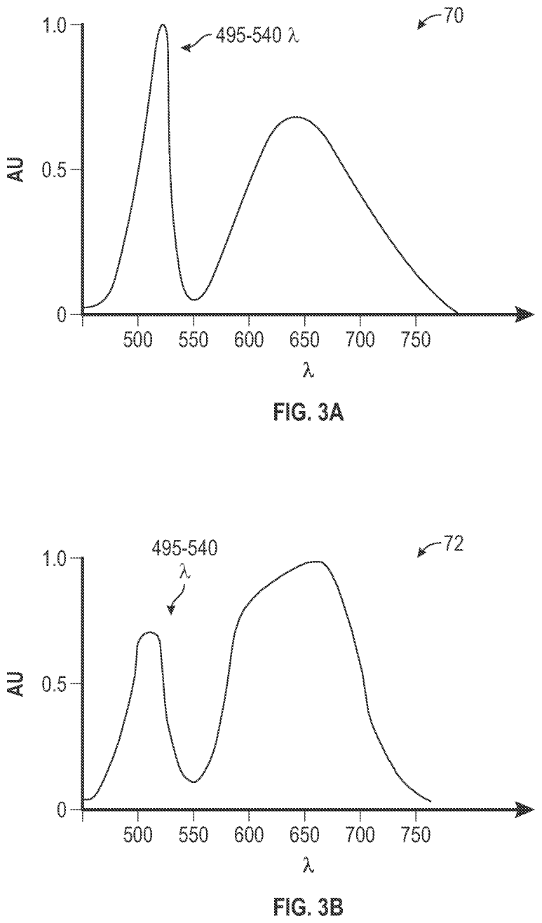

The diffusion plate 26 is configured to reduce the amount of visible blue light from the visible light generated by the plurality of LEDs 20. It is to be appreciated that visible blue light may contribute to digital eye strain. In addition to reducing the amount of visible blue light, the diffusion plate 26 also increases the amount of visible light emitted in other color frequencies as well. Referring now to FIGS. 3A and 3B, two different visible light spectrum graphs 70, 72 are shown. The graph 70 in FIG. 3A represents an exemplary visible light spectrum generated by a conventional reading lamp, and the graph 72 in FIG. 3B represents an exemplary visible light spectrum generated by the disclosed reading lamp 18. The x-axis of the graphs 70, 72 represent wavelength (A) in nanometers and the y-axis represents absorption measured in absorption units (AU). As seen in FIG. 3A, the conventional reading light generates almost 40% more blue light, which includes frequencies ranging from about 495 to about 540 nanometers, when compared to the remaining color frequencies in the visible light spectrum. The remaining color frequencies include green light (ranging from about 495 to about 570 nanometers), yellow light (ranging from about 570 to about 590 nanometers), orange light (ranging from about 590 to about 620 nanometers), and red light (ranging from about 620 to about 750 nanometers).

Referring now to FIG. 3B, the disclosed reading lamp 18 generates substantially less visible blue light when compared to a conventional reading lamp. Specifically, the diffusion plate 26 is configured to adsorb at least enough visible blue light from the visible light emitted by the LEDs 20 to result in a visible light spectrum including an amount of visible blue light that is equal to or less than a remainder of color frequencies in the visible light spectrum. In the embodiment as illustrated in FIG. 3B, the diffuser plate 26 adsorbs enough visible blue light to result the reading lamp 18 emitting less of the visible blue light when compared to the remainder of color frequencies in the visible light spectrum.

Table One, which is reproduced below, compares various characteristics of the visible light generated by a conventional reading lamp and an exemplary reading lamp 18 that includes a diffuser plate 26 with the spectral properties shown in FIG. 3B as well as the anti-glare plate 28. It is to be appreciated that the characteristics listed in Table One represent only one example of the reading lamp 18. Therefore, the reading lamp 18 is not limited to the specific values as shown in Table One.

The characteristics listed in Table One include a Correlated Color Temperature (CCT), a luminous efficiency (Im) that is expressed as a percentage, a Color Rendering Index (CRI), a Color Quality Scale (CQS), and an R value R9. The CCT rating of a lamp indicates the color appearance. Specifically, the CCT rating indicates if a light source generates visible light having a warm or cool appearance. Light sources with a CCT rating below 3200 Kelvin are usually classified as warm, while those with a CCT rating above 4000 Kelvin are usually classified as cool in appearance. The CRI defines how accurately a light source reproduces an illuminated object's color when compared to a reference light source of comparable color temperature. The CRI is a unitless quantity, where higher CRI values correspond to better color rendering, where the maximum value is 100. The CQS is an alternative to the CRI. However, instead of only eight unsaturated or pastel colors, the CQS evaluates fifteen colors that more accurately span the range of object colors. The CQS also considers chromatic discrimination and human preference. Similar to the CRI, the maximum value of the CQS is also 100.

The R value R9 is now explained. The CRI includes fifteen colors ranging from R1 to R15. However, the CRI score is calculated by averaging the scores of only the first eight colors (R1-R8), which are a variety of unsaturated, pastel colors. Colors R9-R15 are not calculated into the CRI score but may be considered individually. R9 correlates to a strong red color. As an example of the remaining colors R9-R15, the color R10 correlates to a strong yellow, while color R8 correlates to a light reddish purple.

TABLE ONE

| | Conventional | |
|---|---|---|
| Characteristic | Reading Lamp | Reading Lamp 18 |
| Correlated Color | 5895 | 3778 |
| Temperature (CCT) | | |
| luminous efficiency | 100% | 68% |
| (lm) | | |
| Color Rendering | 70 | 82 |
| Index (CRI) | | |
| Color Quality Scale | 69 | 78 |
| (CQS) | | |
| R9 | −22 | 24 |

As seen in Table One, the CCT of both reading lamps are above 3200 Kelvin and therefore do not generate visible light that includes a warm appearance. However, the conventional reading lamp includes a CCT that is above 4000 Kelvin, and therefore emits light that is cool in appearance. Furthermore, the reading lamp 18 provides improved CRI and CQS scores. Moreover, the R value indicates the disclosed reading lamp 18 also emits significantly more red light when compared to the conventional reading lamp.

Referring back to FIG. 1, the anti-glare plate 28 is positioned within the open end 32 of the housing 10. The anti-glare plate 28 is configured to increase central (on-axis) candela intensity when compared to a Lambertian source. A Lambertian source represents a light source having a radiance that is uniform across a surface and uniformly emits light in all directions from the surface. In an embodiment, the anti-glare plate 28 increases central candela intensity by about twenty-five percent. Table Two, which is shown below, summarizes improved glare values for three exemplary anti-glare plates and a Lambertian source. Referring to Table Two, anti-glare plate 1 includes a thickness of about 1.5 millimeters, anti-glare plate 2 includes a thickness of about 1.2 millimeters, and anti-glare plate 3 includes a thickness of about 0.8 millimeters. As the thickness of the anti-glare plate 28 decreases the glare created improves (i.e., a lower percentage is better). Furthermore, as the thickness of the anti-glare plate 28 decreases, the gain increases and the beam angle decreases. As seen in Table Two, the anti-glare plate 28 may increase central candela intensity by up to 25%. Specifically, a gain 125% (seen in Anti-Glare plate 3) results in an increase of central candela intensity of about 25%. An increase in central candela intensity results in improved focusing abilities and also enhances lighting efficiency.

TABLE TWO

| | | | Beam Angle (Full |
|---|---|---|---|
| | | | Width, Half Max) |
| Anti-Glare Plate | Glare | Gain | in degrees |
| Anti-Glare Plate 1 | 20% | 115% | 100 |
| Anti-Glare Plate 2 | 18% | 120% | 95 |
| Anti-Glare Plate 3 | 15% | 125% | 90 |
| Lambertian source | 40% | 100% | 120 |

The anti-glare plate 28 is configured to reduce the unified glare rating (UGR) of the visible light generated by the LEDs 20 that exits the reading lamp to a satisfactory level. Specifically, the reading lamp 18 produces visible light having a UGR of 19 or less. The UGR is a method of calculating glare from luminaires, light through windows, and bright light sources. A UGR of 19 or less indicates that a luminaire does not create uncomfortable glare for a user and provides a satisfactory level of glare. It is to be appreciated that some conventional reading lamps that are presently used may have relatively high UGRs of 26 or more. A UGR of 26 provides an uncomfortable glare to a user. Therefore, in some instances, the anti-glare plate 28 reduces the UGR from an uncomfortable level to a satisfactory level.

The anti-glare plate 28 includes an upper surface 52 is exposed to the environment and a lower surface 54 that opposes the diffuser plate 26. A plurality of light scattering microstructures 56 are disposed along the upper surface 52 of the anti-glare plate 28. Specifically, the plurality of light scattering microstructures 56 are disposed along a surface (i.e., the upper surface 52) of the anti-glare plate 28 and are oriented to face away from the visible light generated by the plurality of LEDs 20.

The plurality of light scattering microstructures 56 are nano-sized. The plurality of light scattering microstructures 56 each include a substantially rounded or semi-circular profile. Although a rounded profile is illustrated in FIG. 1, it is to be appreciated that the light scattering microstructures 56 may include other profiles as well. In one embodiment, the anti-glare plate 28 is constructed of polycarbonate, however it is to be appreciated that the anti-glare plate 28 may also be constructed of other substantially transparent materials as well. Furthermore, in one example, the anti-glare plate 28 includes a thickness of about 0.8 millimeters, however it is to be appreciated that other dimensions may be used as well.

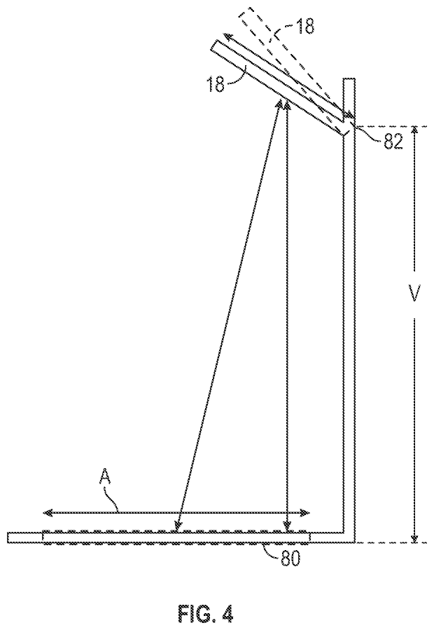

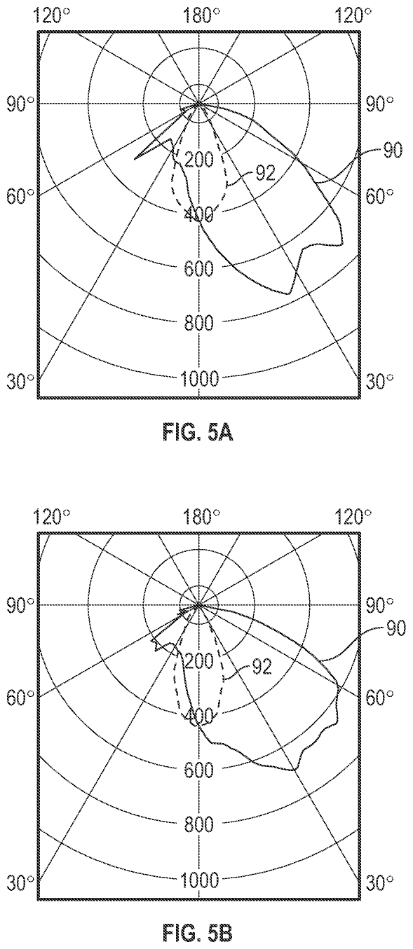

FIG. 4 illustrates an exemplary a tilt-angle simulation setup for the reading lamp 18, and FIGS. 5A and 5B illustrate exemplary polar intensity diagrams generated based on the tilt-angle simulation. Specifically, FIG. 5A represents the results at a tilt of about thirty degrees, and FIG. 5B represents the results at a tilt of about forty five degrees. Referring now to FIG. 4, the solid lines represent the reading lamp 18 positioned at about forty five degrees relative to a vertical plane, while the dashed lines represent the reading lamp 18 positioned at about thirty degrees relative to a vertical plane. The reading lamp 18 is positioned at a vertical distance V, which is measured from a ground surface 80 to an end portion 82 of the reading lamp 18. It is to be appreciated that the reading lamp 18 is configured to illuminate the same area A located along the ground surface 80 when positioned at a first angle (i.e., the thirty degree angle) as well as a second angle (i.e., the forty five degree angle). Specifically, the nano-sized microstructures 56 (FIG. 1) are configured to direct the visible light generated by the LEDs 20 towards a fixed area (i.e., area A) along the surface 80 as the reading lamp 18 is tilted into two or more different angular positions. Therefore, if the reading lamp 18 is employed in an automobile, then the reading lamp 18 may be placed in different positions within an interior cabin of the automobile without changing the lighted area relative to a passenger or driver's side seat.

FIGS. 5A and 5B both illustrate the distribution of luminous intensity, in candelas, for a first flux intensity 90 in the 0°-180° plane and a second flux intensity 92 in the 90°-270° plane. The first flux intensity 90 and the second flux intensity 92 remain substantially identical, even as the reading lamp 18 is tilted from about thirty degrees to forty five degrees.

Referring generally to the figures, the disclosed edge-lit reading lamp offer various technical effects and benefits. Specifically, in one embodiment, the entire height of the housing containing the LEDs of the edge-lit reading lamp is about four millimeters. In contrast, some conventional reading lamps include a height of about fourteen millimeters. Therefore, the disclosed reading lamp requires significantly less space and is much easier to package. Furthermore, the disclosed reading lamp also provides high quality visible light having a satisfactory UGR value (19 or less) and a decreased amount of blue light when compared to conventional reading lamps. Some conventional reading lamps may not produce visible light having a satisfactory UGR value. Furthermore, the visible light produced by conventional reading lamps may also include significant amounts of visible blue light, which may cause digital eye strain.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An edge-lit reading lamp for an automobile, comprising:
a housing having an open end and one or more sidewalls;
a plurality of light emitting diodes (LEDs) disposed along the one or more sidewalls of the housing, wherein the plurality of LEDs are configured to emit visible light, and wherein the visible light includes blue visible light;
a light guide plate surrounded by the plurality of LEDs;
a diffuser plate positioned to receive the visible light emitted by the plurality of LEDs, wherein the diffuser plate includes light diffusion particles configured to adsorb at least enough of the visible blue light from the visible light emitted by the plurality of LEDs to result in a visible light spectrum including an amount of the visible blue light that is equal to or less than a remainder of color frequencies in the visible light spectrum; and
an anti-glare plate having a plurality of light scattering microstructures disposed along a surface of the anti-glare plate that are oriented to face away from the visible light generated by the plurality of LEDs.

2. The edge-lit reading lamp of claim 1, wherein the anti-glare plate is configured to reduce a unified glare rating (UGR) of the visible light generated by the plurality of LEDs that exits the reading lamp to a satisfactory level.

3. The edge-lit reading lamp of claim 2, wherein the satisfactory level is 19.

4. The edge-lit reading lamp of claim 1, wherein the plurality of light scattering microstructures are nano-sized.

5. The edge-lit reading lamp of claim 1, wherein the plurality of light scattering microstructures each include a substantially rounded profile.

6. The edge-lit reading lamp of claim 1, wherein the anti-glare plate is positioned within the open end of the housing.

7. The edge-lit reading lamp of claim 1, wherein the plurality of LEDs are white LEDs.

8. The edge-lit reading lamp of claim 1, further comprising a light reflective film disposed along an inner bottom surface of the housing.

9. The edge-lit reading lamp of claim 8, wherein the light reflective film includes a thickness of about 0.3 millimeters.

10. The edge-lit reading lamp of claim 1, wherein the light guide plate includes a thickness of about two millimeters.

11. The edge-lit reading lamp of claim 1, the diffuser plate adsorbs enough visible blue light to result in the edge-lit reading lamp emitting less of the visible blue light when compared to the remainder of color frequencies in the visible light spectrum.

12. The edge-lit reading lamp of claim 1, wherein the diffuser plate includes a thickness of about 0.3 millimeters.

13. The edge-lit reading lamp of claim 1, wherein the anti-glare plate includes a thickness of about 0.8 millimeters.

14. The edge-lit reading lamp of claim 1, wherein the housing includes a height of about four millimeters.

15. The edge-lit reading lamp of claim 1, wherein the light diffusion particles are constructed of at least one of the following: titanium dioxide (TiO₂), silicon dioxide (SiO₂), aluminum oxide (Al₂O₃), hollow SiO₂, zinc oxide (ZrO₂), and cerium oxide (CeO₂), and wherein the light diffusion particles include a particle diameter of ranging from about 5 nanometers to about 200 nanometers.

16. An edge-lit reading lamp, comprising:
a housing having an open end and one or more sidewalls, wherein the housing includes a height of about four millimeters;
a plurality of white LEDs disposed along the one or more sidewalls of the housing, wherein the plurality of white LEDs are configured to emit visible light, and wherein the visible light includes blue visible light;
a light guide plate surrounded by the plurality of white LEDs;
a diffuser plate positioned to receive the visible light emitted by the plurality of white LEDs, wherein the diffuser plate includes light diffusion particles configured to adsorb at least enough of the visible blue light from the visible light emitted by the plurality of white LEDs to result in a visible light spectrum including an amount of the visible blue light that is equal to or less than a remainder of color frequencies in the visible light spectrum; and
an anti-glare plate having a plurality of light scattering microstructures disposed along a surface of the anti-glare plate that are oriented to face away from the visible light generated by the plurality of LEDs.

17. The edge-lit reading lamp of claim 16, wherein the anti-glare plate is configured to reduce a unified glare rating (UGR) of the visible light generated by the plurality of LEDs that exits the reading lamp to a satisfactory level.

18. The edge-lit reading lamp of claim 17, wherein the satisfactory level is 19.

19. The edge-lit reading lamp of claim 16, wherein the plurality of light scattering microstructures are nano-sized.

20. The edge-lit reading lamp of claim 16, wherein the light diffusion particles are constructed of at least one of the following: titanium dioxide (TiO₂), silicon dioxide (SiO₂), aluminum oxide (Al₂O₃), hollow SiO₂, zinc oxide (ZrO₂), and cerium oxide (CeO₂), and the light diffusion particles include a particle diameter of ranging from about 5 nanometers to about 200 nanometers.
